(19) United States
(12) Patent Application Publication
(10) Pub. No.: US 2005/0087144 A1
(43) Pub. Date: Apr. 28, 2005

(54) Method of reducing evaporation in systems that maintain aquatic life

(76) Inventor: Samuel P. Hopkins, Freedom, PA (US)

Correspondence Address: Samuel P. Hopkins, 538 Hamilton Blvd, Freedom, PA, 15042, US

(21) Appl. No.: 10/962,771

(22) Filed: Oct. 13, 2004

Related U.S. Application Data
(60) Provisional application No. 60/514,812, filed on Oct. 27, 2003.

(51) Int. Cl. A01K 63/00

(52) U.S. Cl. 119/233

(57) ABSTRACT

The present invention provides for a new method of reducing evaporation in systems that maintain aquatic life by using compounds that are less dense than water that when added to said systems would float and sit upon the surface of the water in the system and reduce evaporation by forming a barrier between the water and the surrounding air. The barrier is formed by adding various compounds to the water. The compounds rise to the surface of the water, sit upon the surface of the water, spread out, and form a barrier to reduce evaporation by limiting the amount of water that is exposed to the surrounding air.

### CROSS REFERENCE TO RELATED APPLICATIONS

Provisional application 60/514,812, filed Oct. 27, 2003—Method of Reducing Evaporation in Systems That Maintain Aquatic Life.

### FIELD OF THE INVENTION

The present invention pertains to a method for reducing evaporation in self contained systems that house aquatic life, and more particularly, pertains to a method of using material that is of a lower density than water to form a floating layer that reduces or stops evaporation in ornamental ponds, aquariums, and other systems that house aquatic life.

### BACKGROUND OF THE INVENTION

As used herein, systems used to house aquatic life comprises of aquariums, ornamental ponds, and other bodies of water that are used to support aquatic life. Water replacement in these systems because of water loss through evaporation consumes time and resources and is the number one maintenance task that must be performed. If it is ignored, all of the water will eventually evaporate and the aquatic life will be destroyed. Furthermore, as water evaporates any chemicals or minerals that do not evaporate at the same rate as the water will grow in concentration and potentially make it inhabitable. It is therefore a great benefit to prevent the evaporation of water contained in these systems.

### SUMMARY OF THE INVENTION

In view of the limitations in the prior art, the present invention provides a new and useful METHOD OF REDUCING EVAPORATION IN SYSTEMS THAT MAINTAIN AQUATIC LIFE which is simpler, more universally usable and more versatile in operation than known methods of this kind.

The purpose of the present invention is to provide a new METHOD OF REDUCING EVAPORATION IN SYSTEMS THAT MAINTAIN AQUATIC LIFE that has many novel features not offered by the prior art that results in a new METHOD OF REDUCING EVAPORATION IN SYSTEMS THAT MAINTAIN AQUATIC LIFE which is not apparent, obvious, or suggested, either directly or indirectly by any of the prior art.

The present invention provides for a new method of reducing evaporation in systems that maintain aquatic life by using compounds that are less dense than water that when added to said systems would float and sit upon the surface of the water in the system and reduce evaporation by reducing the contact area of the water's surface to the surrounding air.

The foregoing has outlined, in general, the aspects of the invention and is to serve as an aid to better understanding the more complete detailed description which is to follow. In reference to such, there is to be a clear understanding that the present invention is not limited to the method or detail of construction, composition, fabrication, material, or application of use described and illustrated herein. Any other variation of fabrication, use, or application should be considered apparent as an alternative embodiment of the present invention.

### DETAILED DESCRIPTION OF THE INVENTION

The general purpose of the present invention is to provide a method for reducing evaporation from self contained systems that house aquatic life, for example aquariums and ornamental ponds, by forming a layer that floats on top of the water thereby forming a layer between the water contained in these systems and the surrounding air. This layer acts to insulate the water from the surrounding air which reduces evaporation. This layer is created by adding to the system compounds that are less dense than water. The compounds will float to the surface of the water and spread out to form a layer on the surface of the water. Once the layer is spread out it reduces the amount of evaporation that occurs by sitting between the water's surface and the surrounding air. If more than the required amount of layer forming compound is applied it will tend to form a lens on the surface of the water. If portions of the layer are later removed for whatever reasons this extra compound will replace the compound that has been removed and the lens will shrink in size. The layer degrades slowly over a course of time. After the layer is degraded a new application of the chemical compound is applied to regain the evaporation reducing benefits.

The evaporation reducing layer can be made from any liquid or solid such as liquid and solid fatty acids, liquid or solid fatty alcohols, petroleum-based liquids, vegetable based liquids, fruit and nut based liquids, or any other oils, liquids, or solids that tend to float.

Some liquids spread out quicker than others and these are preferred. The present invention has found that mixing a petroleum-based liquid with either fatty acids or a low viscosity liquid such as grapeseed oil in preferably the amount of 1 part petroleum-based liquid to 1/24^{th} part fatty acid or low viscosity liquid is enough to enable the layer to spread out more quickly. The present invention has also found that by adding powder such as diatomaceous earth to a liquid preferably in the amount of 1 part liquid to 1/24^{th} part powder also increases the spreading rate of the layer. The present invention also has found that spreading of the layer can be accelerated by adding an alcohol which evaporates quickly, such as isopropyl alcohol or similar alcohol, to the compound. When the compound containing isopropyl alcohol is placed into the water the isopropyl alcohol evaporates quickly from the surface of the water producing kinetic energy that causes the other floating compounds in the layer to spread out.

Another significant aspect of the present invention is that when the compounds are added to the water they last for an extended period of time because they degrade slowly. This fact is important as the present invention provides a solution to decrease maintenance time for the user by reducing the amount of “top offs” of water that they must do. Furthermore the present invention can be administered through the use of a dropper bottle or measuring spoon and can be purchased in small quantities.

### EXAMPLES

The following Examples illustrate various embodiments of the methods according to the present Invention.

### Example 1

This example illustrates a method of reducing evaporation in self contained systems that house aquatic life by forming a layer upon the water's surface that is comprised completely of a petroleum-based product¹, such as mineral oil. This composition when added to the self-contained system in the amounts preferably of 1 drop per 6 square feet is usually adequate to form a layer that reduces evaporation.

### Example 2

This example illustrates a method of reducing evaporation in self contained systems that house aquatic life by forming a layer upon the water's surface that is comprised of a petroleum-based product¹, such as mineral oil and isopropyl alcohol or similar alcohol preferably in the amounts of 1 part petroleum-based product¹ to 1/24^{th} part isopropyl alcohol or similar alcohol. This composition should be shaken vigorously and then immediately administered before the two parts separate. This composition when added to the self-contained system in the amounts preferably of 1 drop per 6 square feet is usually adequate to form a layer that reduces evaporation.

### Example 3

This example illustrates a method of reducing evaporation in self contained systems that house aquatic life by forming a layer upon the water's surface that is comprised of a petroleum-based product¹ such as mineral oil and a fatty acid² preferably in the amount of 1 part petroleum-based product¹ and 1/24^{th} part fatty acid². All components should be mixed together to form the composition. This composition when added to the self-contained system in the amounts preferably of 1 drop per 6 square feet is usually adequate to form a layer that reduces evaporation.

### Example 4

This example illustrates a method of reducing evaporation in self contained systems that house aquatic life by forming a layer upon the water's surface that is comprised of a petroleum-based product¹, such as mineral oil and a fatty alcohol³ such as cetyl alcohol preferably in the amount of 1 part petroleum-based product¹ and 1/24^{th} part fatty alcohol³. When the fatty alcohol³ is a solid at room temperature the petroleum-based product¹ can be heated to 200 degrees and then have the fatty alcohol³ added. This melts the fatty alcohol and disperses it throughout the petroleum-based product¹. All components should be mixed together to form the composition. This composition when added to the self-contained system in the amounts preferably of 1 drop per 6 square feet is usually adequate to form a layer that reduces evaporation.

### Example 5

This example illustrates a method of reducing evaporation in self contained systems that house aquatic life by forming a layer upon the water's surface that is comprised of a petroleum-based product¹, such as mineral oil, a fatty alcohol³ such as cetyl alcohol and a fatty acid² such as oleic acid preferably in the amounts of 1 part petroleum-based product¹, 1/24^{th} part fatty alcohol³ and 1/24^{th} part fatty acid². When the fatty alcohol³ is a solid at room temperature the petroleum-based product¹ can be heated to 200 degrees and then have the fatty alcohol³ added. This melts the fatty alcohol³ and distributes it throughout the petroleum-based product³. All components should be mixed together to form the composition. This composition when added to the self-contained system in the amounts preferably of 1 drop per 6 square feet is usually adequate to form a layer that reduces evaporation.

### Example 6

This example illustrates a method of reducing evaporation in self contained systems that house aquatic life by forming a layer upon the water's surface that is comprised of a petroleum-based product¹, such as mineral oil, a fatty acid² such as oleic acid and isopropyl alcohol or similar alcohol preferably in the amount of 1 part petroleum-based product¹, 1/24^{th} part fatty acid² and 1/24^{th} part isopropyl alcohol or similar alcohol. This composition should be shaken vigorously and then immediately administered before the two parts separate. This composition when added to the self-contained system in the amounts preferably of 1 drop per 6 square feet is usually adequate to form a layer that reduces evaporation.

### Example 7

This example illustrates a method of reducing evaporation in self contained systems that house aquatic life by forming a layer upon the water's surface that is comprised of a petroleum-based product¹, such as mineral oil, a fatty alcohol³ such as cetyl alcohol and isopropyl alcohol or similar alcohol preferably in the amount of 1 part petroleum-based product¹, 1/24^{th} part fatty alcohol³ and 1/24^{th} part isopropyl alcohol or similar alcohol. When the fatty alcohol³ is a solid at room temperature the petroleum-based product¹ can be heated to 200 degrees and then have the fatty alcohol³ added. This melts the fatty alcohol³ and distributes it throughout the petroleum-based product¹. All components should be mixed together to form the composition. This composition when added to the self-contained system in the amounts preferably of 1 drop per 6 square feet is usually adequate to form a layer that reduces evaporation.

### Example 8

This example illustrates a method of reducing evaporation in self contained systems that house aquatic life by forming a layer upon the water's surface that is comprised of a petroleum-based product¹, such as mineral oil, a fatty acid² such as oleic acid and isopropyl alcohol or similar alcohol preferably in the amount of 1 part petroleum-based product¹, 1/24^{th} part fatty acid² and 1/24^{th} part isopropyl alcohol or similar alcohol. This composition should be shaken vigorously and then immediately administered before the two parts separate. This composition when added to the self-contained system in the amounts preferably of 1 drop per 6 square feet is usually adequate to form a layer that reduces evaporation.

### Example 9

This example illustrates a method of reducing evaporation in self contained systems that house aquatic life by forming a layer upon the water's surface that is comprised of a petroleum-based product¹, such as mineral oil, a fatty alcohol³ such as cetyl alcohol, a fatty acid² such as oleic acid and isopropyl alcohol or similar alcohol preferably in the amount of 1 part petroleum-based product¹, 1/24^{th} part fatty alcohol³, 1/24^{th} part fatty acid² such as oleic acid and 1/24^{th} part isopropyl alcohol or similar alcohol. When the fatty alcohol is a solid at room temperature the petroleum-based product¹ can be heated to 200 degrees and then have the fatty alcohol³ added. This melts the fatty alcohol³ and distributes it throughout the petroleum-based product¹. All components should be mixed together to form the composition. This composition when added to the self-contained system in the amounts preferably of 1 drop per 6 square feet is usually adequate to form a layer that reduces evaporation.

### Example 10

This example illustrates a method of reducing evaporation in self contained systems that house aquatic life by forming a layer upon the water's surface that is comprised completely of a fatty acid² such as oleic acid. This composition when added to the self-contained system in the amounts preferably of 1 drop per 6 square feet is usually adequate to form a layer that reduces evaporation.

### Example 11

This example illustrates a method of reducing evaporation in self contained systems that house aquatic life by forming a layer upon the water's surface that is comprised of fatty acid² such as oleic acid and isopropyl alcohol or similar alcohol preferably in the amount of 1 part fatty acid² such as oleic acid and 1/24^{th} part isopropyl alcohol or similar alcohol. This composition should be shaken vigorously and then immediately administered before the two parts separate. This composition when added to the self-contained system in the amounts preferably of 1 drop per 6 square feet is usually adequate to form a layer that reduces evaporation.

### Example 12

This example illustrates a method of reducing evaporation in self contained systems that house aquatic life by forming a layer upon the water's surface that is comprised of fatty acid² such as oleic acid and a fatty alcohol³ such as cetyl alcohol preferably in the amount of 1 part fatty acid² such as oleic acid and 1/24^{th} part fatty alcohol³. When the fatty alcohol³ is a solid at room temperature the fatty acid² such as oleic acid can be heated to 200 degrees and then have the fatty alcohol³ added. This melts the fatty alcohol³ and distributes it throughout the fatty acid². All components should be mixed together to form the composition. This composition when added to the self-contained system in the amounts preferably of 1 drop per 6 square feet is usually adequate to form a layer that reduces evaporation.

### Example 13

This example illustrates a method of reducing evaporation in self contained systems that house aquatic life by forming a layer upon the water's surface that is comprised of fatty acid² such as oleic acid, a fatty alcohol³ such as cetyl alcohol and isopropyl alcohol or similar alcohol preferably in the amount of 1 part fatty acid² such as oleic acid, 1/24^{th} part fatty alcohol³ and 1/24^{th} isopropyl alcohol or similar alcohol. When the fatty alcohol³ is a solid at room temperature, the fatty acid² such as oleic acid can be heated to 200 degrees and then have the fatty alcohol³ added. This melts the fatty alcohol³ and distributes it throughout the fatty acid². All components should be mixed together to form the composition. This composition when added to the self-contained system in the amounts preferably of 1 drop per 6 square feet is usually adequate to form a layer that reduces evaporation.

### Example 14

This example illustrates a method of reducing evaporation in self contained systems that house aquatic life by forming a layer upon the water's surface that is comprised completely of a fatty alcohol³ such as cetyl alcohol. If the fatty alcohol³ is liquid it can be added in preferably the amounts of 1 drop per 6 square feet to provide an adequate layer to reduce evaporation. If the fatty alcohol³ is solid it can be processed into a fine powder between 1 and 100 microns. This powdered composition when added to the self-contained system in the amounts preferably of 1/16 teaspoon per 6 square feet is adequate to form a layer that reduces evaporation.

### Example 15

This example illustrates a method of reducing evaporation in self contained systems that house aquatic life by forming a layer upon the water's surface that is comprised of fatty alcohol³ such as cetyl alcohol and isopropyl alcohol or similar alcohol preferably in the amount of 1 part fatty alcohol³ and 1/24^{th} part isopropyl alcohol or similar alcohol. All components should be mixed together to form the composition. This composition when added to the self-contained system in the amounts preferably of 1 drop per 6 square feet is usually adequate to form a layer that reduces evaporation.

### Example 16

This example illustrates a method of spreading evaporation retardant compounds through the kinetic energy produced by alcohol evaporating.

### Example 17

This example illustrates a method of reducing evaporation in self contained systems that house aquatic life by forming a layer upon the water's surface that is comprised completely of any oil that is less dense than water. This composition when added to the self-contained system in the amounts preferably of 1 drop per 6 square feet is usually adequate to form a layer that reduces evaporation.

### Example 18

This example illustrates a method of reducing evaporation in self contained systems that house aquatic life by forming a layer of a compound that floats on top of the water's surface.

### Example 19

This example illustrates a method of reducing evaporation in aquariums and ponds by forming a layer of a compound that floats on top of the water's surface.

### Example 20

This example illustrates a method of adding powder, such as diatomaceous earth, to liquids to increase the speed of its spread when used as an evaporation reducing layer.

### Example 21

This example illustrates a method of adding lower viscosity liquids or liquids that exhibit greater spreading rates to lower spreading rate liquids to increase the speed of its spread when used as an evaporation reducing layer.

### Example 22

This example illustrates a method of reducing evaporation in self contained systems that house aquatic life by forming a layer upon the water's surface that is composed of any liquid that is of a lower density than water.

NOTE: For all examples above, the sub-note definitions are as follows:
¹ Petroleum-based product means any petroleum-based product that is liquid, for example mineral oil, any solid petroleum-based product that takes on a fluid state or is dispersed within a fluid, or any combination of petroleum-based products. This term shall also include all petroleum-based products that are less dense than water or are made to float by attaching to or mixing with other products that are less dense than water.

² Fatty acid means any fatty acid, such as oleic acid, any compound that contains fatty acids such as grapeseed oil or omega 9 and any combinations of any fatty acids or compounds that contain fatty acids in any amount. This term shall also include all liquid fatty acids and compounds that contain fatty acids that are less dense than water or are made to float by attaching to or mixing with other products that are less dense than water. This term shall also include any solid fatty acid that takes on a fluid state or is dispersed within a fluid.

³ Fatty alcohol means any fatty alcohol, such as cetyl alcohol, any compound that contains fatty alcohol and any combinations of any fatty alcohol or compounds that contain fatty alcohols in any amount This term shall also include all liquid fatty alcohols and compounds that contain fatty alcohols that are less dense than water or are made to float by attaching to or mixing with other products that are less dense than water. This term shall also include any solid fatty alcohol that takes on a fluid state or is dispersed within a fluid.

It is important to note that while the above examples give specific compositions to form the evaporation reducing layer other layer forming compositions can be created that achieve the same result. Any new compositions not specified within the detailed written description contained herein yet are considered apparent or obvious to one skilled in the art and are within the scope of the present invention.

It is also important to note that the isopropyl alcohol or similar alcohol used in the various methods is used to provide an emulsion with the cetyl alcohol, if present, and/or to provide a means to disperse the other chemicals across the water's surface through the kinetic energy produced when the isopropyl alcohol or similar alcohol evaporates.

It is further intended that any other embodiments of the present invention that result from any changes in application or method of use or operation, method of manufacture, shape, size, or material which are not specified within the detailed written description contained herein yet are considered apparent or obvious to one skilled in the art and are within the scope of the present invention.

1. A method of reducing evaporation in systems that maintain aquatic life comprising of:
a. adding a less dense component to the body of water wherein the less dense component floats to the surface of the water and forms a layer.

2. A method as set forth in claim 1 where said layer is a monolayer.

3. A method as set forth in claim 1 where said less dense component does not affect the chemistry of the water.

4. A method as set forth in claim 1 where said less dense component does affect the chemistry of the water.

5. A method as set forth in claim 1 wherein said less dense component comprises of oil.

6. A method as set forth in claim 1 wherein said less dense component comprises of fatty alcohol.

7. A method as set forth in claim 1 wherein said less dense component comprises of fatty acid.

8. A method as set forth in claim 1 wherein said less dense component comprises of oil, fatty alcohol, fatty acid, and isopropyl alcohol.

9. A method of improving the spreading abilities of evaporation reducing components comprising of:
a. combining the evaporation reducing components with addition component or components that interact in such a way as to spread the evaporation reducing components faster or further than it would by itself.

10. A method as set forth in claim 9 wherein the additional component is another oil which posses a different viscosity.

11. A method as set forth in claim 9 wherein the additional component is a fine powder.

12. A method as set forth in claim 9 wherein the additional component is oleic acid.

13. A method as set forth in claim 9 wherein the additional component is isopropyl alcohol.

14. A method as set forth in claim 9 wherein the additional component is cetyl alcohol.

15. A method of improving the spreading abilities of evaporation reducing component comprising of:
a. combining the evaporation reducing component with an additional component or components that evaporates quickly and provides kinetic energy to expand the evaporation reducing component across the water.

16. A method as set forth in claim 15 where the evaporation component is alcohol.

17. A method as set forth in claim 15 where the evaporation component is isopropyl alcohol.
